(19) United States
(12) Patent Application Publication
(10) Pub. No.: US 2008/0152034 A1
(43) Pub. Date: Jun. 26, 2008

(54) Scanning operations in wireless networks based on location service data

(76) Inventors: Huaiyu Liu, Portland, OR (US); Emily H. Qi, Portland, OR (US); Jr-Shian Tsai, Beaverton, OR (US)

Correspondence Address: CAVEN & AGHEVLI;c/o INTELLEVATE, LLC, P.O. BOX 52050, MINNEAPOLIS, MN, 55402, US

(21) Appl. No.: 11/645,102

(22) Filed: Dec. 22, 2006

(51) Int. Cl. H04L 25/00

(52) U.S. Cl. 375/295

(57) ABSTRACT

Methods and apparatus to improve scanning operations in wireless networks are described. In one embodiment, a wireless device transmits a scan request to an access point controller to cause the access point controller to determine one or more future neighboring access points of the wireless device. Other embodiments are also described.

### BACKGROUND

The present disclosure generally relates to the field of electronics. More particularly, an embodiment of the invention generally relates to techniques for improving scanning operations in wireless networks based on location service data.

Wireless networks have become an integral part of computing. Before connecting to and utilizing a service provided through a wireless network, a wireless device may need to scan through various channels for available services. To perform the scan, components of the wireless device need to consume power. Also, the scan may introduce latency, e.g., associated with determining available wireless services. Moreover, the scanning may need to be done periodically because of changes that may occur when a wireless device is moved or as a result of changes to the wireless network infrastructure. Accordingly, scanning operations may increase power consumption and add latency.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-3 illustrate various components of embodiments of communication systems, which may be utilized to implement one or more embodiments.

FIG. 4 illustrates a flow diagram of a method, according to an embodiment of the invention.

FIG. 5 illustrates a block diagram of an embodiment of a computing system, which may be utilized to implement various embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

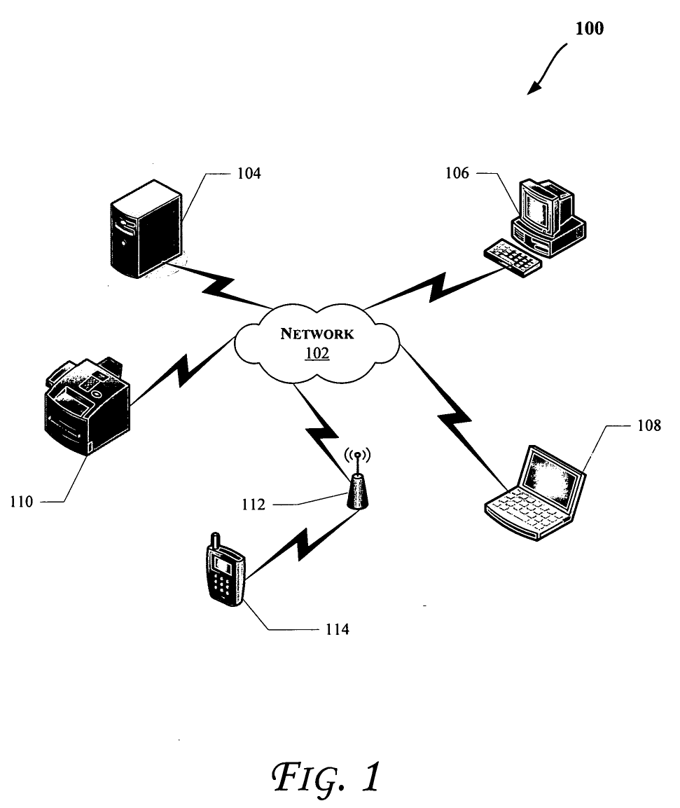

Some of the embodiments discussed herein may be applied in various computing environments such as those discussed with reference to FIGS. 1-5. More particularly, FIG. 1 illustrates various components of an embodiment of a communication system 100, which may be utilized to implement some embodiments discussed herein. The system 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a wireless access point 112, a personal digital assistant or smart phone 114, a rack-mounted computing system (not shown), etc. The network 102 may be any type of type of a computer network including an intranet, the Internet, and/or combinations thereof.

The devices 104-114 may communicate with the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In some embodiments, more than one access point 112 may be in communication with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) such as a network interface card (NIC) or external network interface devices (e.g., having a separate physical enclosure and/or power supply than the computing system to which it is coupled).

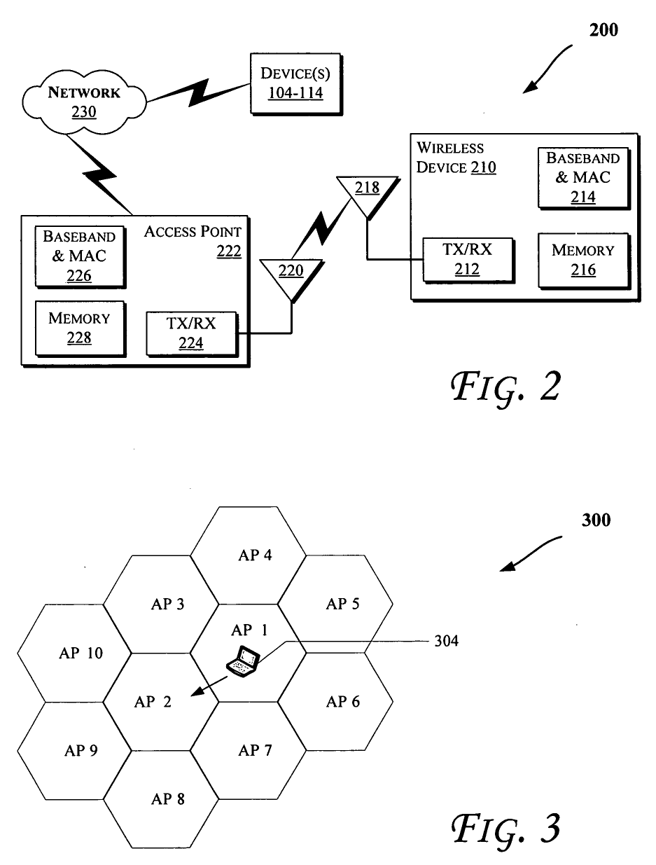

Referring to FIG. 2, a block diagram of a wireless local area or cellular network communication system 200 in accordance with one or more embodiments of the invention will be discussed. In the communication system 200 shown in FIG. 2, a wireless device 210 may include a wireless transceiver 212 to couple to an antenna 218 and to a logic 214 such as a processor (e.g., to provide baseband and media access control (MAC) processing functions). In some embodiment, one or more of the devices 104, 106, 108, 110, or 114 of FIG. 1 may include one or more of the components discussed with reference to the wireless device 210. Hence, in an embodiment, the devices 104, 106, 108, 110, or 114 of FIG. 1 may be the same or similar to the wireless device 210. In one embodiment of the invention, wireless device 210 may be a cellular telephone or an information handling system such as a mobile personal computer or a personal digital assistant or the like that incorporates a cellular telephone communication module. Logic 214 in one embodiment may comprise a single processor, or alternatively may comprise a baseband processor and an applications processor. Logic 214 may couple to a memory 216 which may include volatile memory such as dynamic random-access memory (DRAM), non-volatile memory such as flash memory, or alternatively may include other types of storage such as a hard disk drive. Some portion or all of memory 216 may be included on the same integrated circuit as logic 214, or alternatively some portion or all of memory 216 may be disposed on an integrated circuit or other medium, for example a hard disk drive, that is external to the integrated circuit of logic 214.

Wireless device 210 may communicate with access point 222 via a wireless communication link, where access point 222 may include one or more of: an antenna 220, a transceiver 224, a processor 226, and a memory 228. In one embodiment, access point 222 may be a base station of a cellular telephone network, and in an embodiment, access point 222 may be a an access point or wireless router of a wireless local or personal area network. In some embodiment, the access point 112 of FIG. 1 may include one or more of the components discussed with reference to the access point 222. Hence, in an embodiment, the access point 112 of FIG. 1 may be the same or similar to the access point 222. In an embodiment, access point 222 (and optionally wireless device 210) may include two or more antennas, for example to provide a spatial division multiple access (SDMA) system or a multiple input, multiple output (MIMO) system. Access point 222 may couple with network 230 (which may be the same or similar to the network 102 of FIG. 1 in some embodiments) so that wireless device 210 may communicate with network 230, including devices coupled to network 230 (e.g., one or more of the devices 104-114), by communicating with access point 222 via a wireless communication link. Network 230 may include a public network such as a telephone network or the Internet, or alternatively network 230 may include a private network such as an intranet, or a combination of a public and a private network. Communication between wireless device 210 and access point 222 may be implemented via a wireless local area network (WLAN). In one embodiment, communication between wireless device 210 and access point 222 may be at least partially implemented via a cellular communication network compliant with a Third Generation Partnership Project (3GPP or 3G) standard. In some embodiments, antenna 218 may be utilized in a wireless sensor network or a mesh network.

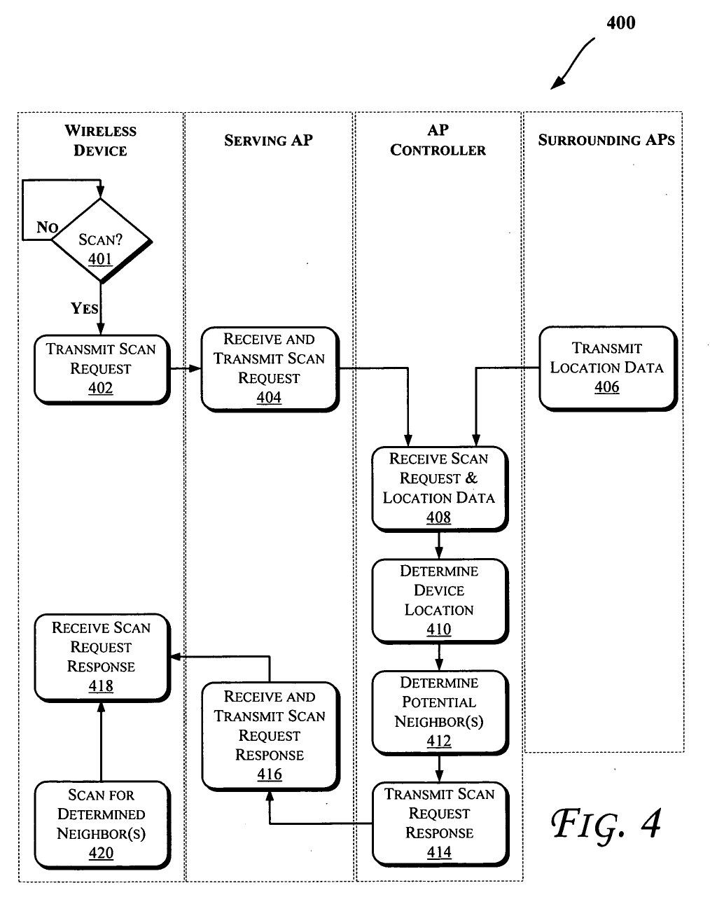

FIG. 3 illustrates various components of an embodiment of a communication system 300, which may be utilized to implement one or more embodiments of the invention. As shown in FIG. 3, the system 300 may include a plurality of access points (APs). A wireless device 304 (which may be one of the devices 210 of FIG. 2 and/or devices 104-110 or 114 of FIG. 1) may move between various access points. For example, the device 304 may be moving from its currently serving access point (AP1) towards another access point (AP2) as indicated by the arrow. Further details regarding the operations that may be performed as the device 304 moves between various access points will now be discussed with reference to FIG. 4.

FIG. 4 illustrates a block diagram of an embodiment of a method 400 to improve scanning operations in wireless networks. In an embodiment, the method 400 may improve scanning operations in wireless networks based on location service data. In an embodiment, various components discussed with reference to FIGS. 1-3 and 5 may be utilized to perform one or more of the operations discussed with reference to FIG. 4. For example, the method 400 may be used to improving scanning operations performed by devices 104-110, 114, 210, and/or 304 discussed with reference to FIGS. 1-3.

Referring to FIGS. 1-4, at an operation 401, it is determined whether a scan is to be performed, e.g., to determine availability of services through a wireless network. For example, one of the devices 104-110, 114, 210, and/or 304 may determine at operation 401 whether to scan for services available through a corresponding wireless network. In an embodiment, the operation 401 may determine that a scan is to be performed once the signal strength of a serving AP drops below a selected threshold, e.g., the device 304 determines that signal strength of AP1 has dropped below a threshold level, for example, indicating that the device 304 is moving away from AP1 and possibly towards a different AP (e.g., AP2). In an embodiment, operation 401 may be performed after the wireless device connects to the serving AP.

At an operation 402, a wireless device (e.g., one of the devices 104-110, 114, 210, and/or 304) may transmit a scan request. In an embodiment, the wireless device may use a roaming management query frame (RMQF) to send out this request. In one embodiment, the scan request may indicate that the roaming query reason is for scanning.

At an operation 404, a serving access point (e.g., AP1 of FIG. 3) may receive the scan request and transmit it to an access point controller (e.g., one of the access points 112, 222, and/or APs shown in FIG. 3 or one of the devices 104-110 and/or 114 of FIG. 1. etc.). At an operation 406, one or more of surrounding access points (e.g., access points 112, 222, and/or APs shown in FIG. 3) may transmit location data (e.g., indicating the location of a wireless device such as the device 304) to the access point controller. In an embodiment, one or more APs (e.g., including the serving AP or non-serving APs) that receive the scan request of operation 402 may respond with location data at operation 406. Hence, in an embodiment, only APs that are within the reach of the scan request signal of operation 402 may respond with location data at operation 406. In an embodiment, the location data transmitted at operation 406 may be provided in accordance with Institute of Electrical and Electronics Engineers (IEEE) 802.11v standard.

At an operation 408, the AP controller may receive the scan request (e.g., operation 404) and location data (e.g., operation 406). The AP controller may determine the location of the wireless device (e.g., device 304) at an operation 410. Based on location (and relative change in location data such as relative AP signal strength), the AP controller may determine the neighbor(s) of the AP by which the device is served and/or the AP the device is heading towards. For example, the AP controller may determine that the device 304 is moving from AP1 to AP2 based on relative location data and/or signal strengths of the surrounding APs at operation 410. In one embodiment, data corresponding to the previous location of the wireless device may be either stored by the AP controller or included in the scan request transmitted at operation 402 to enable the AP controller to determine the relative change in location of the wireless device.

At operation 412, the AP controller may determine the potential neighbor(s) of AP1 and/or AP2 based on one or of the following information that may be available to the AP controller: (1) a list of all the APs in the corresponding network (e.g., networks 102 or 230); (2) location of each AP; and/or (3) nearest neighbors of each AP (e.g., a neighbor list). In an embodiment, the AP controller may determine the location of the wireless device based on comparison of data received from a plurality of wireless devices such as, for example, the devices 104-114 of FIG. 1. Furthermore, in an embodiment, at operation 412, the AP controller may take an intersection of neighbor lists of a first access point (e.g., AP1 which may be the serving AP of the wireless device 304) and a second access point (e.g., AP2 which may be the AP the wireless device 304 is heading towards, for example, as determined based on relative location data and/or relative signal strength data provided at operation 406). For instance, in the example shown in FIG. 3, if the device 304 is determined to move from AP1 to AP2, then the recommended scan list provided at operation 414 may include AP3, AP7, and AP2.

At an operation 414, the scan request response (which may include neighbor information of operation 412) may be transmitted to the serving AP. At an operation 416, the serving AP receives the scan request response and transmits it to the corresponding wireless device. At an operation 418, the wireless device may receive the scan request response which may include information regarding which APs (and/or corresponding channels) the wireless device is to scan during a next scan for wireless services. At an operation 420, the wireless device scans for the determined neighbor(s). In some embodiments, at operation 420, the wireless device may limit its channel scans to channels associated with the potential neighbor(s) that are determined at operation 412. Such embodiments may reduce power consumption by components of the wireless device and/or reduce latency (e.g., associated with scanning other channels that may be utilized by non-neighboring APs, for example, device 304 would not scan the channels associated with AP4, AP5, AP6, etc.). Further, such embodiments may enable fast roaming and/or applications such as always-on-always-connected.

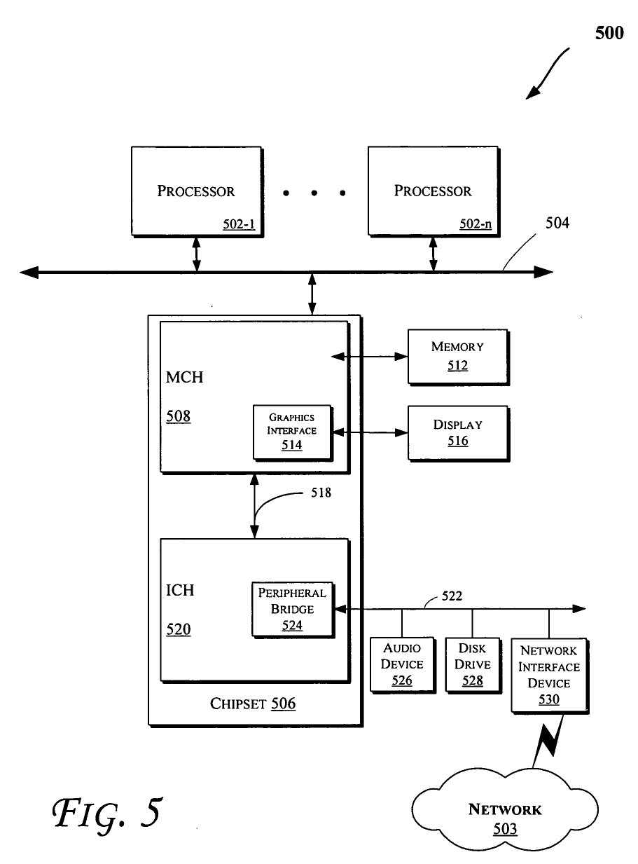

FIG. 5 illustrates a block diagram of an embodiment of a computing system 500. One or more of the devices 104-114 of FIG. 1 and/or devices 210 or 222 of FIG. 2 may comprise the computing system 500. The computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. Moreover, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512. The memory 512 may store data, including sequences of instructions that are executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a display 516. In one embodiment of the invention, the graphics interface 514 may communicate with the display 516 via an accelerated graphics port (AGP). In an embodiment of the invention, the display 516 may be a flat panel display that communicates with the graphics interface 514 through, for example, a signal converter that translates a digital representation of an image stored in a storage device such as video memory or system memory into display signals that are interpreted and displayed by the display 516. The display signals produced by the interface 514 may pass through various control devices before being interpreted by and subsequently displayed on the display 516.

A hub interface 518 may allow the MCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530, which may be in communication with the computer network 503. In an embodiment, the device 530 may be a NIC capable of wireless communication. In an embodiment, the network 503 may be the same or similar to the networks 102 of FIG. 1 and/or 230 of FIG. 2. In one embodiment, the network interface device 530 may include one or more components of the wireless device 210 of FIG. 2. Also, the device 530 may be the same or similar to the device 210 of FIG. 2 in some embodiments. Other devices may communicate via the bus 522. Also, various components (such as the network interface device 530) may communicate with the MCH 508 in some embodiments of the invention. In addition, the processor 502 and the MCH 508 may be combined to form a single chip. Furthermore, the graphics accelerator 516 may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a wireless device to transmit a scan request to an access point controller to cause the access point controller to determine one or more neighbors of a first access point and a second access point,
wherein the access point controller is to determine one or more access points for the wireless device to scan based on a result of an intersection of one or more neighbors of the first access point and one or more neighbors of the second access point.

2. The apparatus of claim 1, wherein the access point controller is to receive location data corresponding to a location of the wireless device from one or more of the first access point or the second access point.

3. The apparatus of claim 1, wherein the access point controller is to determine a moving direction of the wireless device based on location data corresponding to a location of the wireless device.

4. The apparatus of claim 1, wherein the access point controller is to determine the second access point based on location data corresponding to a location of the wireless device and a moving direction of the wireless device.

5. The apparatus of claim 1, wherein the first access point and the second access point are neighboring access points.

6. The apparatus of claim 1, wherein the access point controller is to determine one or more neighbors of the second access point based on location data corresponding to a location of the wireless device and wherein the first access point and the second access point are neighboring access points.

7. The apparatus of claim 1, wherein the first access point is to couple the wireless device to a wireless network.

8. The apparatus of claim 1, wherein the access point controller receives location data corresponding to a location of the wireless device from a plurality of access points that receive the scan request.

9. The apparatus of claim 1, wherein the wireless device comprises one or more of a processor, a memory, a transceiver, or an antenna.

10. A method comprising:
transmitting a scan request from a wireless device to an access point controller;
receiving location data corresponding to a location of the wireless device from a plurality of access points;
determining a change in the location of the wireless device based on the location data and previous location data corresponding to a previous location of the wireless device;
determining one or more neighboring access points of a first access point and a second access point based on the change in the location of the wireless device; and
transmitting information corresponding to the one or more neighboring access points to the wireless device.

11. The method of claim 10, further comprising storing one or more instructions in a computer readable medium to cause one or more processors to perform one or more operations comprising:
determining the location of the wireless device; or
determining the one or more neighboring access points.

12. The method of claim 10, further comprising the plurality of access points receiving the scan request.

13. The method of claim 10, further comprising the first access point coupling the wireless device to a wireless network.

14. The method of claim 10, wherein the first access point and the second access point are neighboring access points.

15. The method of claim 14, further comprising determining a list indicating one or more corresponding channels of potential access points for the wireless device to scan based on a result of an intersection of the one or more neighbors of the first access point and one or more neighbors of the second access point.
